(19) United States
(12) Patent Application Publication
(10) Pub. No.: US 2025/0080608 A1
(43) Pub. Date: Mar. 6, 2025

(54) STORAGE SYSTEM AND STORAGE SYSTEM CONTROL METHOD

(71) Applicant: Hitachi, Ltd., Tokyo (JP)

(72) Inventors: Yugo YAMAUCHI, Tokyo (JP); Mitsuo HAYASAKA, Tokyo (JP)

(21) Appl. No.: 18/584,831

(22) Filed: Feb. 22, 2024

(30) Foreign Application Priority Data
Sep. 6, 2023 (JP) 2023-144323

(51) Int. Cl. H04L 67/1097; H04L 67/1004

(52) U.S. Cl. CPC H04L 67/1097; H04L 67/1004

(57) ABSTRACT

A storage system includes a plurality of storage servers that includes a storage device and a controller that processes data inputted to and outputted from the storage device, the plurality of storage servers providing a lead local volume for inputting and outputting data to and from the storage device; and a first compute server including a client, wherein the first compute server manages a free capacity of the plurality of storage servers, individually provisions storage capacity to each of the plurality of storage servers on the basis of the free capacity to provide the lead local volume, and configures a first volume on the basis of the provided plurality of lead local volumes, and provides the first volume to the client.

### BACKGROUND OF THE INVENTION

### 1. Field of the Invention

The present invention relates to a storage system and a storage system control method.

### 2. Description of the Related Art

In order to reduce system portability and load, a container execution base that enables applications to be managed as containers and operations to be automated has been widely used. A container is configured to integrate an application execution environment so that the container can be used as an individual server. In addition, the container execution base is a tool for efficiently operating and managing containers, and is also referred to as a container orchestrator.

In a case where a volume to be scaled out from the container execution base is required as per U.S. Pat. No. 9,678,683, a large-capacity, scale-out volume is created on the storage side and provided to the container execution base. The scale-out volume referred to herein is a volume having a volume capacity which can be increased by adding nodes.

In this case, IO communication between servers occurs on the storage side, and there is a risk of latency degradation. Therefore, as per U.S. Pat. No. 10,003,649B2, a storage server in which data is arranged is calculated on the compute server side, and thus low-latency IO is achieved by directly accessing the storage server.

The storage server is required to provide both a volume to a compute server on the container execution base and a volume to a normal compute server outside the container execution base, and handling of such mixed environments is necessary. In particular, in the case of block storage, usage by a normal compute server involves access using an iSCSI (Internet Small Computer System Interface) or a FC (Fibre Channel), and in order to achieve low latency, a volume to be closed may be created on a single server.

### [PTL 1]

U.S. Pat. No. 9,678,683

### [PTL 2]

U.S. Pat. No. 10,003,649B2

### SUMMARY OF THE INVENTION

In the above-described conventional technology, sometimes the capacity of the storage server cannot be effectively used in cases where the free capacity of the storage server has become non-uniform. For example, in the case of mixed storage usage by a compute server of a container execution base and a compute server outside the container execution base, when the compute server outside the container execution base creates a volume to be closed on a single storage server, a free capacity bias arises between the storage servers. Therefore, when the container execution base creates a scale-out volume, a situation arises, due to the free capacity bias, where the volume cannot be created even though there is a sufficient free capacity in some storage servers. This is because the scale-out volume is for creating a smoothed capacity on each storage server.

In addition, even if the data is created, manual operation is required, and operation labor such as the acquisition of free space and data mapping changes is large.

Therefore, an object of the present invention is to make effective usage of storage capacity.

In order to achieve the above object, one representative example of the storage system of the present invention includes: a plurality of storage servers that includes a storage device and a controller that processes data inputted to and outputted from the storage device, the plurality of storage servers providing a lead local volume for inputting and outputting data to and from the storage device; and a first compute server including a client, wherein the first compute server manages a free capacity of the plurality of storage servers, individually provisions a storage capacity to each of the plurality of storage servers on the basis of the free capacity to provide the lead local volume, and configures a first volume on the basis of the provided plurality of lead local volumes, and provides the first volume to the client.

Furthermore, one representative example of a control method for the storage system of the present invention is a control method for a storage system that includes a plurality of storage servers that includes a storage device and a controller that processes data inputted to and outputted from the storage device, the plurality of storage servers providing a lead local volume for inputting and outputting data to and from the storage device; and a first compute server including a client, the control method including: the first compute server managing a free capacity of the storage device of the plurality of storage servers, individually provisioning storage capacity to each of the plurality of storage servers on the basis of the free capacity to provide the lead local volume, and configuring a first volume on the basis of the provided plurality of lead local volumes, and providing the first volume to the client.

The present invention enables effective usage of storage capacity. Problems, configurations, advantageous effects, and the like other than those described above will be clarified by the descriptions of the embodiments hereinbelow.

### BRIEF DESCRIPTION OF THE DRAWINGS

FIG. 1 is a diagram illustrating an outline of scale-out volume creation processing according to a first embodiment;

FIG. 2 is a diagram illustrating a system configuration diagram according to the first embodiment;

FIG. 3 is a diagram illustrating a HW (hardware) configuration of a computer system according to the first embodiment;

FIG. 3 is a diagram illustrating a HW configuration of a computer system according to the first embodiment (1);

FIG. 4 is a diagram illustrating a HW configuration of a computer system according to the first embodiment (2);

FIG. 5 is a diagram illustrating a HW configuration of a computer system according to the first embodiment (3);

FIG. 6 is a diagram illustrating a HW configuration of a computer system according to the first embodiment (4);

FIG. 7 is a diagram illustrating a HW configuration of a computer system according to the first embodiment (5);

FIG. 8 is a diagram illustrating a HW configuration of a computer system according to the first embodiment (6);

FIG. 9 is a diagram illustrating an example of a data structure of a storage server capacity management table according to the first embodiment;

FIG. 10 is a diagram illustrating an example of a data structure of a server management table according to the first embodiment;

FIG. 11 is a diagram illustrating an example of a storage management program capacity provisioning process flow according to the first embodiment;

FIG. 12 is a diagram illustrating an example of a process flow of a volume provisioning plugin container according to the first embodiment;

FIG. 13 is a diagram illustrating an example of a storage server and a lead local volume capacity determination flow according to the first embodiment;

FIG. 14 is a diagram illustrating an example of a scale-out volume creation flow according to the first embodiment; and

FIG. 15 is a diagram illustrating an example of a management client management screen according to the first embodiment.

### DESCRIPTION OF THE PREFERRED EMBODIMENTS

Hereinafter, various embodiments will be described with reference to the drawings.

Note that, in the following description, various types of information may be described using the expression “aaa table”; however, the various types of information may be expressed using a data structure other than the table. The “aaa table” can also be referred to as “aaa information” in order to indicate that the information is not dependent upon the data structure.

Further, in the following description, a “network I/F” may include one or more communication interface devices. The one or more communication interface devices may be one or more communication interface devices of the same type (for example, one or more network interface cards (NIC)) or two or more communication interface devices of different types (for example, an NIC and a host bus adapter (HBA)).

In the following description, the configuration of each table is an example; one table may be divided into two or more tables, or all of, or a portion of, two or more tables may be one table.

In addition, in the following description, a storage device 140 is a physical nonvolatile storage device (for example, an auxiliary storage device), for example, a hard disk drive (HDD), a solid state drive (SSD), or a storage class memory (SCM).

In the following description, a “memory 150” includes one or more memories 150. The at least one memory 150 may be the volatile memory 150 or the nonvolatile memory 150. The memory 150 is mainly used for processing by the processor unit.

Furthermore, in the following description, there are cases where processing is described in which the “program” is the subject, but the subject of the processing may be a program because a program is executed by a CPU 160 (Central Processing Unit) to perform defined processing appropriately using a storage unit (for example, the memory 150) and/or an interface unit (for example, a port). The processing, which is described with the program serving as the subject, may be processing performed by a processor unit or a computer (for example, a server) which includes the processor unit.

In the following description, two or more programs may be implemented as one program, or one program may be implemented as two or more programs.

In addition, in the following description, an ID is used as information identifying an element; however, other types of identification information may be used instead of, or in addition to, the ID.

Further, in the following description, in a case where the same kind of elements are described without being distinguished from each other, a number common among the reference signs is used, and in a case where the same kind of elements are described while being distinguished from each other, the reference signs of the elements are sometimes used.

### First Embodiment

In the first embodiment, a method is illustrated in which the capacity of a storage server 40 is acquired by a container compute server 20 and a bare metal compute server 30 to provide a low-latency scale-out volume 300.

### Overview

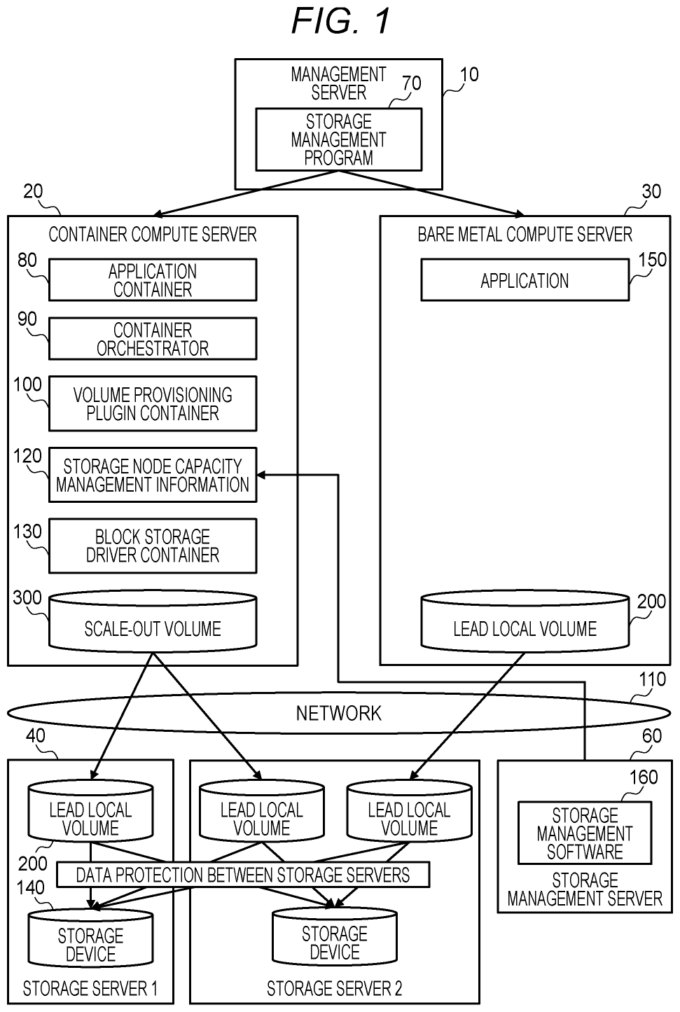

FIG. 1 is a schematic diagram in which a large-capacity scale-out volume 300 is automatically used from the container execution base environment by using the free capacity of the storage server 40.

By referring to the storage node capacity management information 120 in the container compute server 20, the free capacity of the storage server 40 is acquired, an instruction to create the lead local volume 200 is issued to each storage server 40, and a plurality of the lead local volumes are bundled together, thus implementing the use of the scale-out volume 300 from an application container 80 on the container compute server 20.

A system 0 includes a management server 10, a plurality of container compute servers 20, a bare metal compute server 30, and a storage server 40. The management server 10 has a storage management program 70, and receives an instruction regarding storage capacity provisioning from the user. The storage management program 70 determines, from the instruction regarding storage capacity provisioning from the user, whether the instruction is an instruction to the container compute server 20 or an instruction to the bare metal compute server 30. In the case of an instruction to the container compute server 20, the storage capacity provisioning instruction is converted into a volume configuration definition used on a container orchestrator 90 and sent to a volume provisioning plugin container 100. The container compute server 20 holds the volume provisioning plugin container 100, and receives a volume configuration definition from the storage management program 70.

The volume provisioning plugin container 100 communicates with the storage management software 61 of the storage management server 60 and acquires the storage node capacity management information 120.

The volume provisioning plugin container 100 references the free capacity of each storage server 40 from the storage node capacity management information 120 and thus determines whether the scale-out volume 300 can be created.

In a case where the scale-out volume 300 can be created, the volume provisioning plugin container 100 determines the used capacity in each storage server 40.

The volume provisioning plugin container 100 notifies each storage server 40 of the used capacity and requests creation of a lead local volume 200 having that capacity.

Each storage server 40 receives a request from the volume provisioning plugin container 100 and creates a lead local volume 200.

A block storage driver container 130 bundles together a plurality of the lead local volumes 200 created in each storage server 40 to form a scale-out volume 300.

The block storage driver container 130 provides the scale-out volume 300 to the application container 80. The write data is subjected to data protection between the storage servers. The data protection is performed by N-multiplexing between nodes, data protection using a redundancy code (Erasure Coding), or the like.

### <System Configuration>

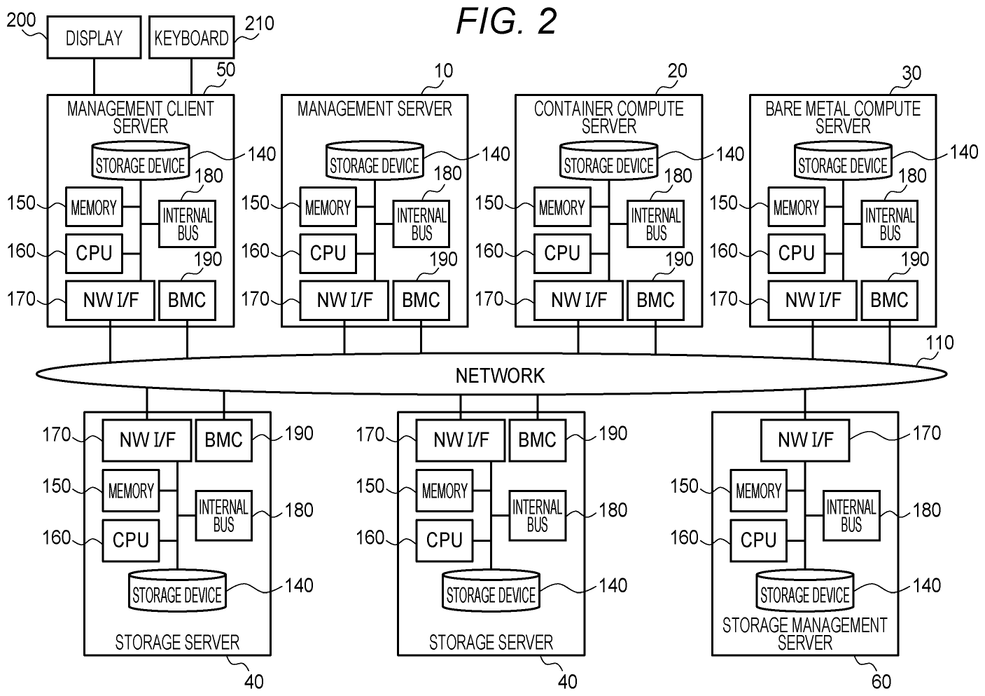

FIG. 2 is an example of the system configuration of the present embodiment.

As illustrated in FIG. 2, the system 0 assumed in the present embodiment includes a plurality of container compute servers 20, a bare metal compute server 30, a management server 10, a storage server 40, a management client server 50, a storage management server 60, and a network 110.

The container compute server 20 is a server that serves as an application compute.

The container compute server 20 is connected, via the network 110, to another container compute server 20 and the storage server 40. The container orchestrator 90 operates on the container compute server 20. On the container compute server 20, the application container 80 is activated by the container orchestrator 90. The application container 80 records data to the storage server 40.

In the container compute server 20, a network interface 170, a BMC 190, the memory 150, the CPU 160, and the storage device 140 are connected to an internal bus 180.

The management client server 50 is a server that accesses the management server 10 and that manages the storage server 40, the container compute server 20, and the bare metal compute server 30. The management client server 50 accesses the management server 10 via the network 110. The user uses the management server 10 from the management client server 50 via the network 110, and uses the volume capacity of the storage server 40. In the management client server 50, the network interface 170, the BMC 190, the memory 150, the CPU 160, and the storage device 140 are connected to the internal bus 180.

The management server 10 is a server that manages the storage capacity provisioning of the container compute server 20 and the bare metal compute server 30. The management server 10 accesses the container compute server and the bare metal compute server via the network 110. In the management server, the network interface 170, the BMC 190, the memory 150, the CPU 160, and the storage device 140 are connected to the internal bus 180.

The bare metal compute server 30 is connected to the storage server 40 through the network 110. On the bare metal compute server 30, an application operates and records data to the storage server 40. In the bare metal compute server 30, the network interface 170, the BMC 190, the memory 150, the CPU 160, and the storage device 140 are connected to the internal bus 180.

The storage server 40 is connected, via the network 110, to each server such as the container compute server 20, the bare metal compute server 30, and the management server 10. A block storage program of the storage server 40 operates and records data. In the storage server 40, the network interface 170, the BMC 190, the memory 150, the CPU 160, and the storage device 140 are connected to the internal bus 180.

The storage management server 60 is connected, via the network 110, to the storage server 40 and the container compute server 20. A storage management program operates on the storage management server 60, and manages the free capacity and the connection destination of the storage server 40. In the storage management server 60, the network interface 170, the BMC 190, the memory 150, the CPU 160, and the storage device 140 are connected to the internal bus 180.

### <Hardware Configuration>

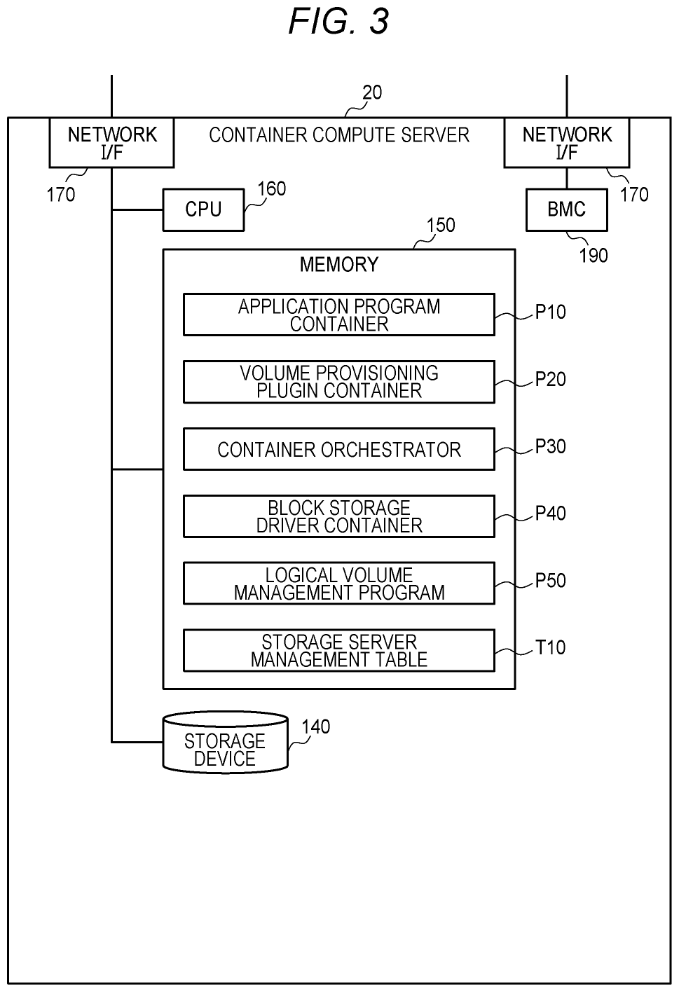

FIG. 3 is a hardware configuration diagram of the container compute server 20.

The container compute server 20 includes a CPU 160, a memory 150, a network interface 170, and a storage device 140.

The memory 150 includes an application program container P10, a volume provisioning plugin container P20, a container orchestrator P30, a block storage driver container P40, a logical volume management program P50, and a storage server capacity management table T10.

The CPU 160 operates as a functional unit that provides predetermined functions by executing processing according to a program in the memory 150.

The application program container P10 is a program with which an application which the user desires to use operates, and which operates under the management of the container orchestrator P30. Processing to use the storage capacity of the storage server 40 is performed.

The volume provisioning plugin container P20 is a program that calculates the capacity to be provisioned to the application program container P10 from the free capacity of each storage server 40 and that notifies each storage server 40 to create the lead local volume 200. The volume provisioning plugin container P20 performs processing to acquire the free capacity and the connection destination of each storage server 40 from the storage management server 60, calculate the used capacity of each storage server 40 from the free capacity, and issue a notification regarding the creation of a lead local volume 200 to each storage server 40.

The container orchestrator P30 is a program that operates in the container compute server 20 and performs activation and operation management of the application program container P10. All programs running on the container compute server 20 are managed as containers by the container orchestrator P30.

The block storage driver container P40 is a program for using a block storage program operating on the storage server 40 from a container on the container orchestrator P30. Processing to utilize the plurality of storage servers 40 is performed according to instructions of the volume provisioning plugin container P20.

The logical volume management program P50 is a program for creating a logical volume so that the block storage can be used as a file system from the application program container P10. Processing to bundle together the plurality of lead local volumes 200 provided by the storage server 40 and thus create one large scale-out volume 300 is performed.

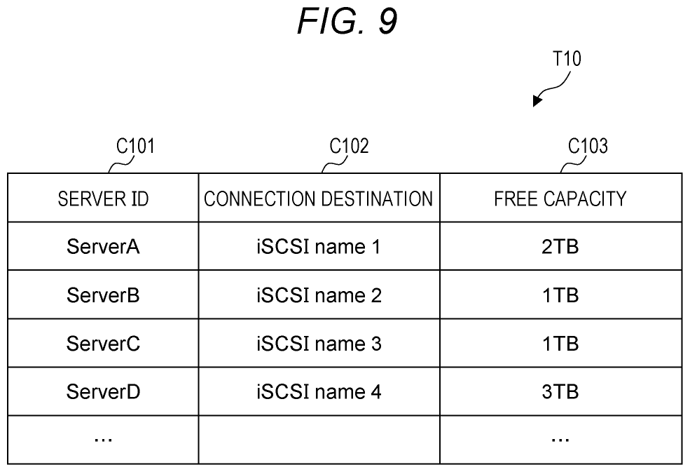

The storage server capacity management table T10 will be described below with reference to FIG. 9.

The BMC 190 is a device that provides a power control interface of the container compute server 20. The BMC 190 operates independently of the CPU 160 and the memory 150, and is capable of receiving and processing a power supply control request from the outside even in a case where failure occurs in the CPU 160 and the memory 150.

The storage device 140 is a non-volatile storage medium storing various programs used by the container compute server 20. An HDD, an SSD, or an SCM can be used as the storage device 140.

The network interface 170 is a communication interface device for connecting to a network.

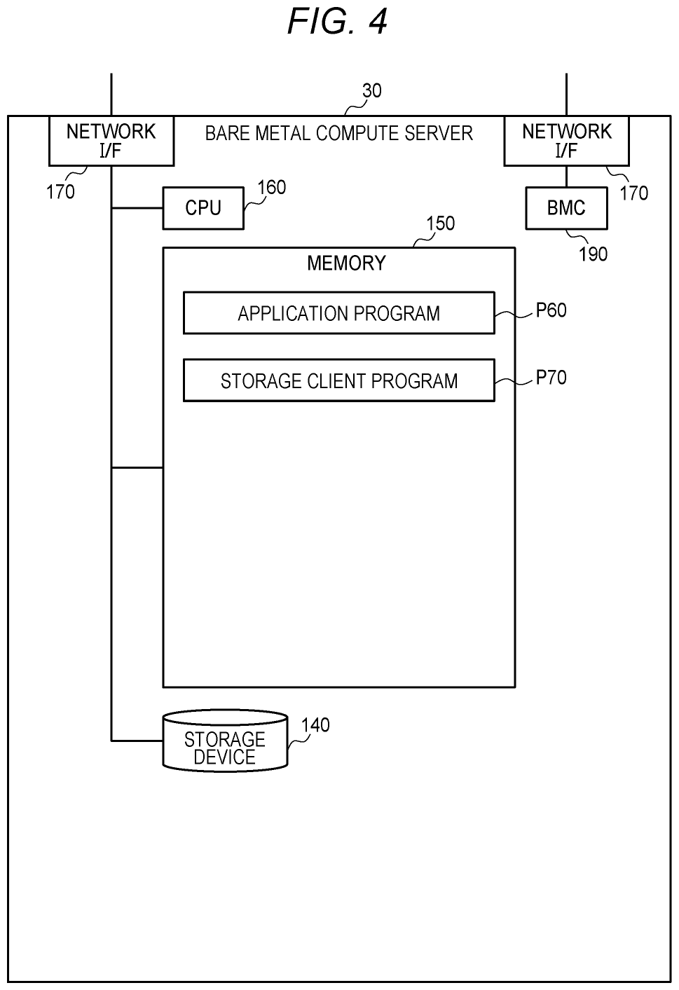

FIG. 4 is a hardware configuration diagram of the bare metal compute server 30.

The bare metal compute server 30 has a CPU 160, a memory 150, a network interface 170, and a storage device 140.

The memory 150 has an application program P60 and a storage client program P70.

The CPU 160 operates as a functional unit that provides predetermined functions by executing processing according to a program in the memory 150.

The application program P60 is a program with which an application which the user desires to use operates. Processing to use the storage capacity of the storage server 40 is performed. The storage client program P70 is a program for using the block storage program of the storage server 40, from the application program P60. Processing to connect to the lead local volume 200 on the storage server 40 is performed.

The BMC 190 is a device that provides a power control interface for the bare metal compute server 30. The BMC 190 operates independently of the CPU 160 and the memory 150, and is capable of receiving and processing a power supply control request from the outside even in a case where failure occurs in the CPU 160 and the memory 150.

The storage device 140 is a non-volatile storage medium storing various programs to be used by the bare metal compute server 30. An HDD, an SSD, or an SCM can be used as the storage device 140.

The network interface 170 is a communication interface device for connecting to a network.

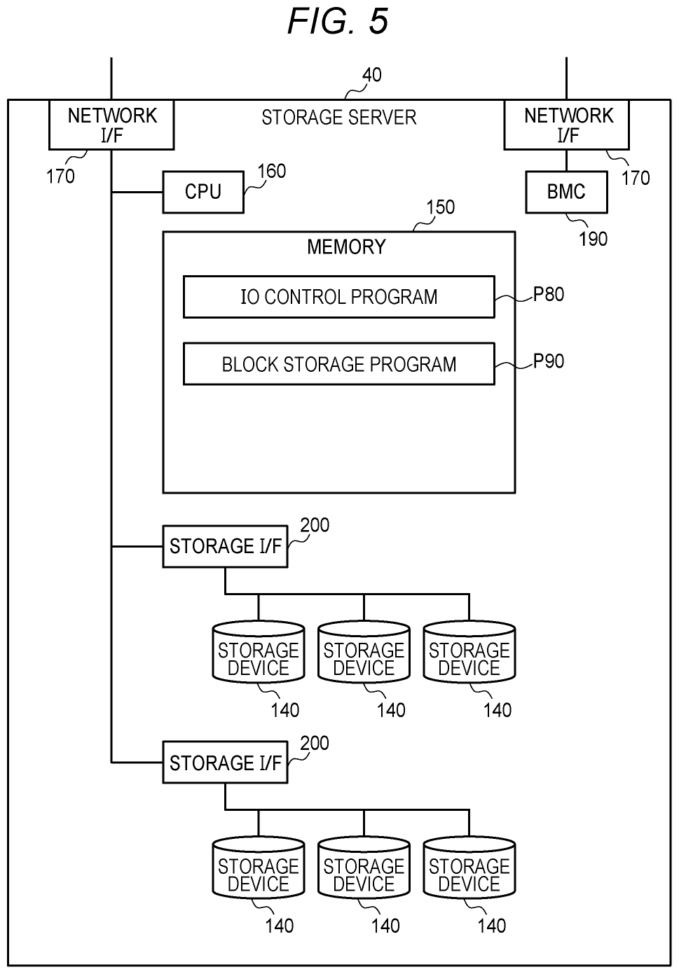

FIG. 5 is a hardware configuration diagram of the storage server 40.

The storage server 40 includes a CPU 160, a memory 150, a network interface 170, and a storage device 140.

The memory 150 includes an IO control program P80 and a block storage program P90.

The CPU 160 operates as a functional unit that provides predetermined functions by executing processing according to a program in the memory 150.

The IO control program P80 is a program that receives reading/writing from the container compute server 20 and the bare metal compute server 30 and that transfers the reading/writing to a block storage program in the storage server 40 serving as the write destination.

The block storage program P90 is a program for saving the reading/writing from the IO control program P80 to a storage device. The block storage program P90 performs processing to determine in which storage device 140 to store the reading/writing from the IO control program P80. In addition, the block storage program P90 plays the role of providing a plurality of integrated storage devices 140 as one storage region.

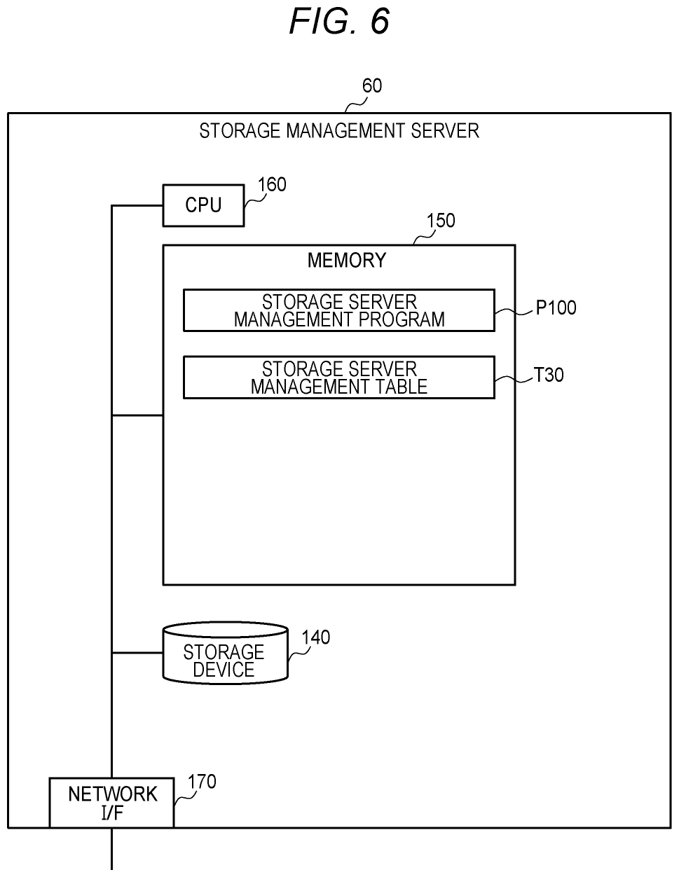

FIG. 6 is a hardware configuration diagram of the storage management server 60.

The storage management server includes a CPU 160, a memory 150, a network interface 170, and a storage device 140.

The memory 150 includes a storage server management program P100 and a storage server management table T30.

The CPU 160 operates as a functional unit that provides predetermined functions by executing processing according to a program in the memory 150.

The storage server management program P100 is a program that holds connection destinations on the storage server 40, the used capacity, and the free capacity, and that performs management. Processing is performed to receive a request to acquire information on the storage server 40 from the volume provisioning plugin container 100 of the container compute server 20, and notify the volume provisioning plugin container 100 of the connection destination and the free capacity of the storage server 40.

The storage device 140 is a non-volatile storage medium storing various programs used by the storage management server 60. An HDD, an SSD, or an SCM can be used as the storage device 140.

The network interface 170 is a communication interface device for connecting to a network.

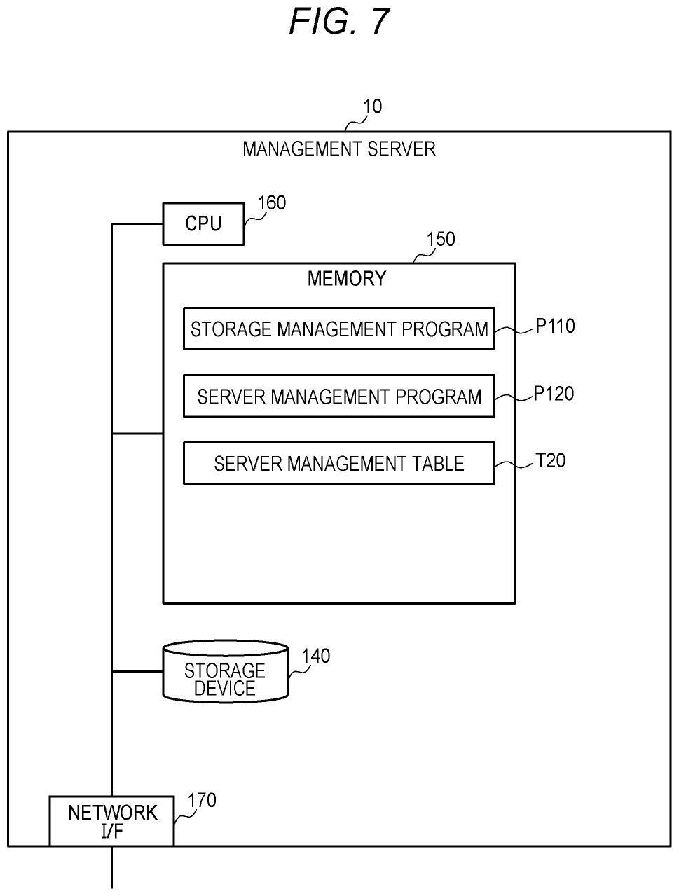

FIG. 7 is a hardware configuration diagram of the management server 10.

The management server 10 includes a CPU 160, a memory 150, a network interface 170, a storage interface, and a storage device 140.

The memory 150 includes a storage management program P110, a server management program P120, and a server management table T20.

The CPU 160 operates as a functional unit that provides predetermined functions by executing processing according to a program in the memory 150.

The storage management program P110 is a program that allows a user to monitor and operate information on the storage server 40.

The server management program P120 is a program which is capable of holding connection destinations and the storage provisioning capacity of the container compute server 20 and the bare metal compute server 30, and which can be monitored and operated by the user. Processing is performed to receive a storage volume provisioning request from the user to the server, determine whether the server is the container compute server 20 or the bare metal compute server 30, and in the case of the container compute server 20, create a volume configuration definition conforming to a standard for the container orchestrator P30, and notify the volume provisioning plugin container P20 regarding the creation of the volume.

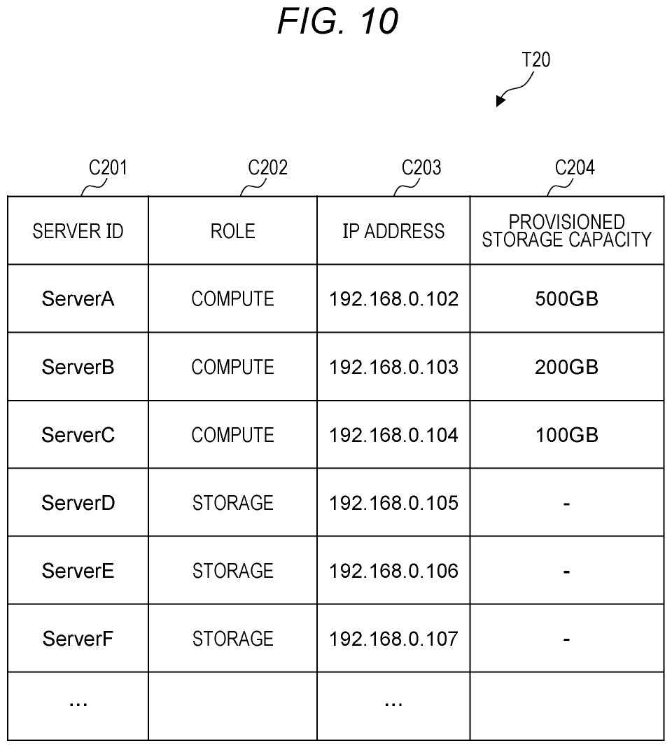

The server management table T20 will be described below with reference to FIG. 10.

The storage device 140 is a non-volatile storage medium storing various programs used by the management server 10. An HDD, an SSD, or an SCM can be used as the storage device 140.

The network interface 170 is a communication interface device for connecting to a network.

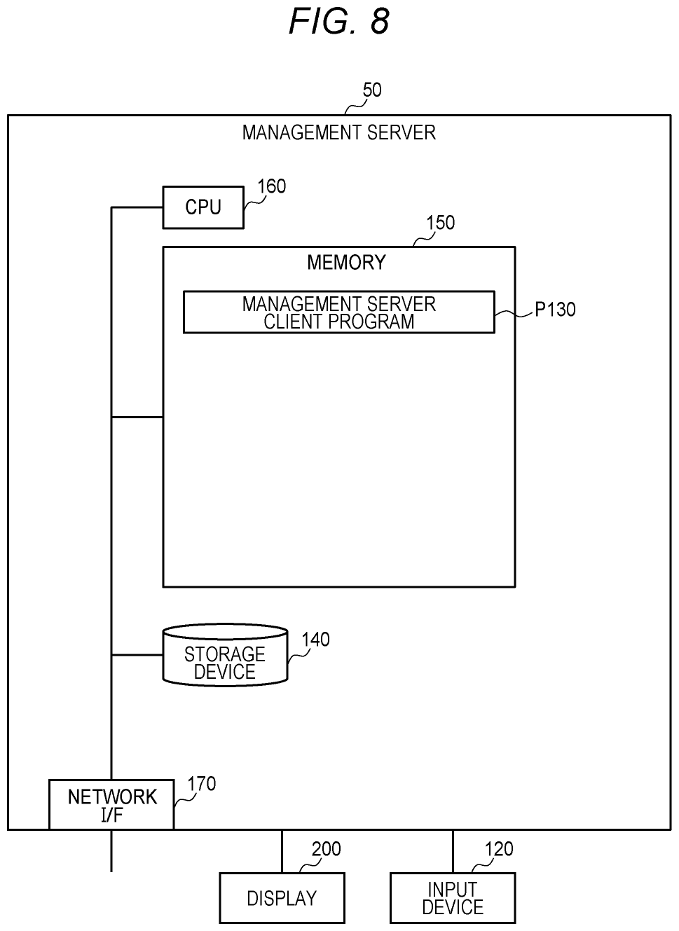

FIG. 8 is a hardware configuration diagram of the management client server 50.

The management client server includes a CPU 160, a memory 150, a network interface 170, a storage interface, and a storage device 140.

The memory 150 has a management server client program P130.

The CPU 160 operates as a functional unit that provides predetermined functions by executing processing according to a program in the memory 150.

The management server client program P130 is a program for the user to connect to the management server 10 and acquire and operate information of the container compute server 20, the bare metal compute server 30, and the storage server 40. The management server client program P130 is connected to the management server 10 and performs processing to communicate with the server management program P120.

The storage device 140 is a non-volatile storage medium storing various programs used by the management client server 50. An HDD, an SSD, or an SCM can be used as the storage device 140.

The network interface 170 is a communication interface device for connecting to a network.

FIG. 9 illustrates a data structure of the storage server capacity management table T10.

The storage server capacity management table T10 stores information of the server ID C101, the connection destination C102, and the free capacity C103.

When the storage server 40 is added, the storage management program P110 adds the server ID C101. When the storage server 40 is added or the connection destination is changed, the storage management program P110 adds or changes the connection destination C102.

When the reference of the free capacity of the storage server 40 is requested from the volume provisioning plugin container P20 or another program, the storage management program P110 communicates with the storage server 40 to add the free capacity C103.

FIG. 10 illustrates a data structure of the server management table T20.

The server management table T20 stores information of a server ID C201, a role C202, an IP address C203, and a storage provisioning capacity C204.

When a server managed by the user is newly added from the management client server 50, the server management program P120 adds the server ID C201, the role C202, and the IP address C203. When a storage capacity provisioning request is received from the management client server 50 to the server managed by the user and the capacity provisioning to the container compute server 20 is successful, the server management program P120 adds the storage provisioning capacity C204.

### <Process Flow>

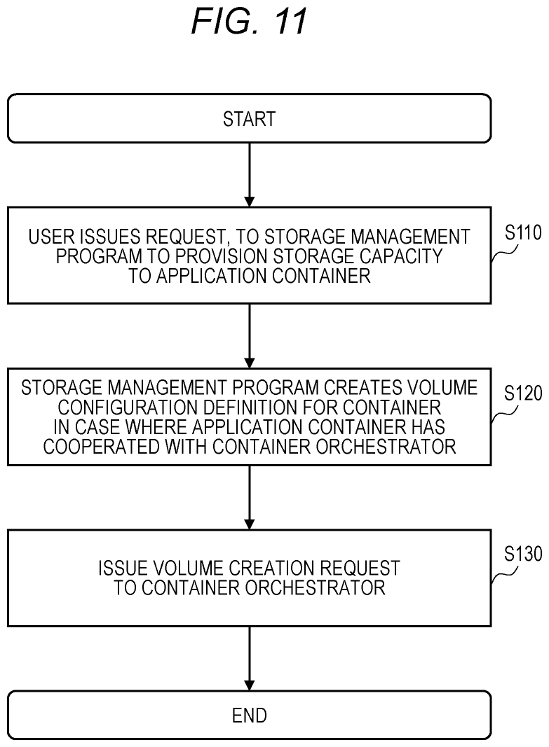

FIG. 11 illustrates a flow in which the storage management program P110 receives a request from the user and provisions storage capacity to the container compute server 20.

S110: The server management program P120 acquires the storage capacity provisioning from the user to the application program container P10.

S120: In a case where the application program container P10 is capable of cooperating with the container orchestrator P30, the server management program P120 creates a volume configuration definition for the container.

S130: The server management program P120 issues a request to create a volume to the volume provisioning plugin container P20 operated by the container orchestrator P30 on the container compute server 20.

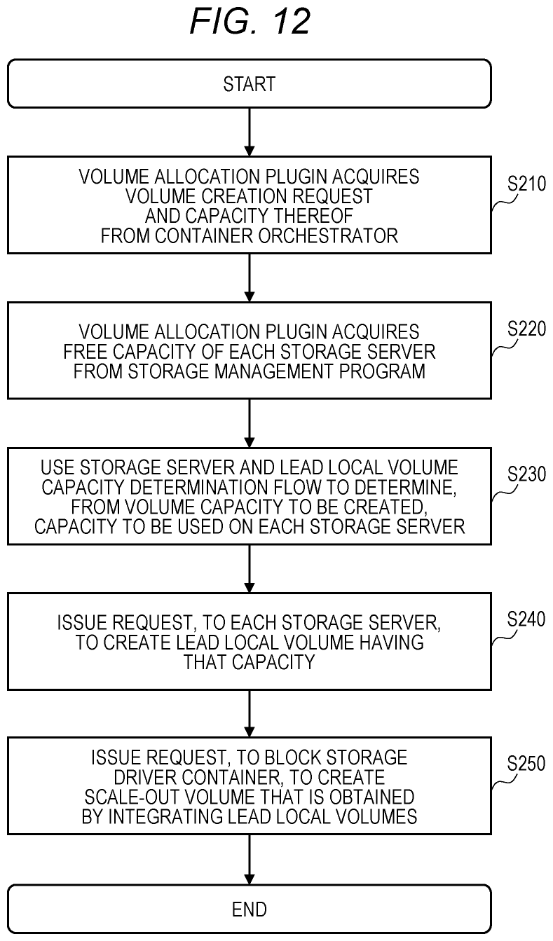

In FIG. 12, the volume provisioning plugin container P20 receives a request from the server management program P120, acquires the free capacity information of the storage server 40, and determines which storage server 40 the capacity is to be used from. In addition, a request to create a lead local volume 200 is issued to each storage server 40, and a request to create a scale-out volume 300 obtained by integrating the lead local volumes 200 is issued to the block storage driver container P40.

S210: The volume provisioning plugin container P20 acquires the volume creation request and the capacity thereof from the container orchestrator P30.

S220: The volume provisioning plugin container P20 acquires the free capacity of each storage server 40 from the storage server management program P100.

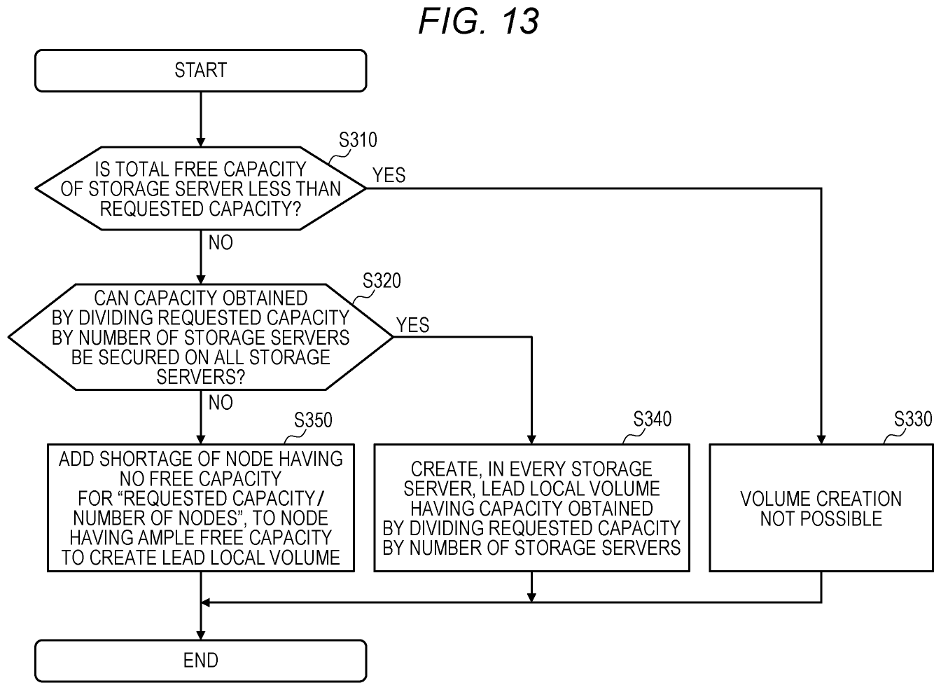

S230: The used capacity of each storage server 40 is determined from the created volume capacity by using the “STORAGE SERVER AND LEAD LOCAL VOLUME CAPACITY DETERMINATION FLOW” in FIG. 13.

S240: Each storage server 40 is requested to create a lead local volume 200 having that capacity.

S250: A request to create a scale-out volume 300 obtained by integrating the lead local volumes 200 is issued to the block storage driver container 130.

FIG. 13 illustrates a flow in which the volume provisioning plugin container P20 receives a request to create volume capacity from the server management program P120, and determines, for the storage servers 40, the capacity of the lead local volume 200 to be created on each storage server 40.

S310: It is determined whether the total free capacity of the storage server 40 is less than the required capacity. If Yes, S330 is performed. If No, S320 is performed.

S320: It is determined whether the capacity obtained by dividing the requested capacity by the number of storage servers 40 can be secured by all the storage servers. If Yes, S340 is performed. If No, S350 is performed.

S330: It is determined that volume creation is impossible, and a response to the effect that volume creation is impossible is sent to the server management program P120. This flow is terminated.

S340: A lead local volume 200 having a capacity obtained by dividing the requested capacity by the number of storage servers 40 is created in all the storage servers 40. This flow is terminated.

S350: The shortage of a storage server 40 having no free capacity, with respect to the capacity obtained by dividing the request capacity by the number of storage servers 40, is added by a storage server 40 having a large free capacity, thereby creating the lead local volume 200. This flow is terminated.

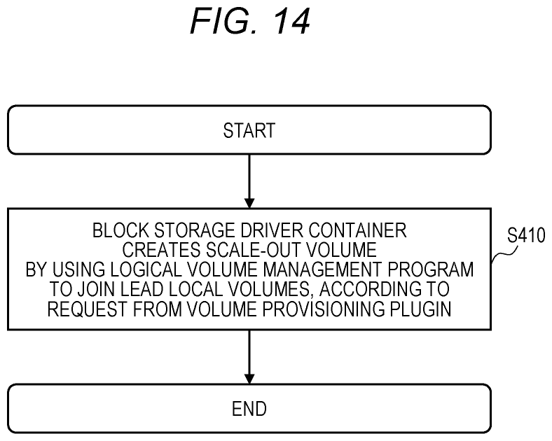

FIG. 14 is a flow in which a scale-out volume 300 of the container compute server 20 is created.

S410: According to the request from the volume provisioning plugin container P20, the block storage driver container P40 combines the lead local volumes 200 by the logical volume management program P50 to create the scale-out volume 300.

### <Management Interface>

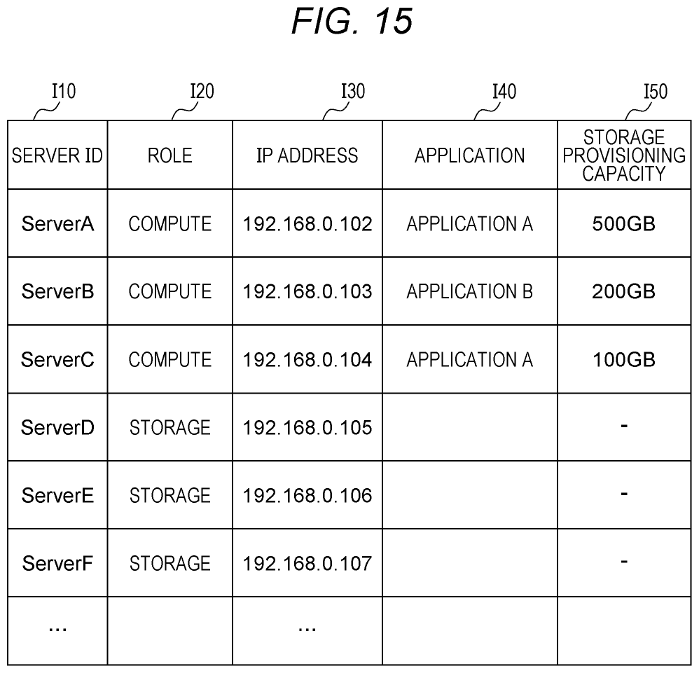

FIG. 15 illustrates an example of a server management interface provided by the management server client program P130.

The administrator is able, via the screen in FIG. 15, to check and set the storage capacities to be provisioned for the servers and applications.

I10: Displays IDs for identifying the servers.

I20: Displays roles for identifying whether the servers are computers or storage.

I30: Displays IP addresses for connecting to the servers.

I40: Displays applications running on the servers. 150: Displays the storage provisioning capacities used by the applications on each server.

### <Increasing Capacity>

In the above description, the new creation of a scale-out volume 300 was described by way of an example; however, it is also possible to increase the capacity of an existing scale-out volume 300. Specifically, the volume provisioning plugin container 100 references the free capacity of each storage server 40 from the storage node capacity management information 120, and provisions the increased storage capacity to a storage server 40 having a large free capacity. At this time, all the increments may be provisioned to one storage server 40 having a sufficiently large free capacity, or the increments may be divided and provisioned so that the free capacities of the plurality of storage servers 40 become equal.

The storage server 40 to which the increased storage capacity is provisioned increases the lead local volume 200 provided to the scale-out volume 300. At this time, the existing lead local volume 200 may be increased, or a new lead local volume 200 corresponding to the increase may be generated.

As described above, the storage system of the disclosure includes: a plurality of storage servers 40 that includes a storage device 140 and a controller that processes data inputted to and outputted from the storage device 140, and that provides a lead local volume 200 for inputting and outputting data to and from the storage capacity of the storage device 140; and a first compute server (container compute server 20) which includes a client. Further, the first compute server manages the free capacity of the plurality of storage servers 40 and, on the basis of the free capacity, individually provisions a storage capacity to each of the plurality of storage servers 40 to provide the lead local volumes 200, configures a first volume (scale-out volume 300) on the basis of the plurality of provided lead local volumes 200, and provides the first volume to the client.

Therefore, it is possible to make effective usage of storage capacity and to provide a low-latency, large-capacity volume.

Further, the first compute server is a server including an environment with a container execution base, the client operates on the container execution base, and a program operating on the container execution base is used to perform management of the free capacity, storage capacity provisioning, and provision of the first volume.

Therefore, the capacity of the plurality of storage servers can be comprehensively managed by the container execution base.

The storage system further includes a second compute server (the bare metal compute server 30) which includes a client, and at least one of the plurality of storage servers provides the lead local volume to each of the first compute server and the second compute server.

Therefore, even in a case where the second compute server causes any of the storage servers to generate a lead local volume, and thus the free capacity between the storage servers becomes non-uniform, the first compute server is capable of generating and providing a large-capacity volume.

That is, in a configuration in which a storage server is used by mixing compute servers, namely, a container compute server which uses a container orchestrator and a bare metal compute server which does not use a container orchestrator, it is possible to implement storage capacity utilization.

In addition, in a case where the storage capacity of the first volume is increased, the first compute server refers to the free capacity of the plurality of storage servers 40 and determines a storage server to which an increased storage capacity is to be provisioned, and the storage server 40 to which the increased storage capacity is provisioned increases the storage capacity provided as the storage capacity of the first volume.

For this reason, volume scale-out becomes straightforward.

In the present invention, the storage management program determines cooperation with the container execution base, creates a volume configuration definition used on the container execution base, and issues a request for volume creation to the volume provisioning plugin.

As a result, a request for volume provisioning can be made from the storage management program to the application container on the container execution base.

In addition, in the present invention, a volume provisioning plugin is prepared on the container execution base. The volume provisioning plugin acquires and holds the free capacity and the connection destination information of each storage server from the storage server management program of the storage management server. As a result, it is possible to use the volume provisioning plugin to refer to the free capacity of the storage servers and thus determine which storage server capacity to use.

In addition, in the present invention, the volume provisioning plugin determines which storage server and which capacity are to be used to create lead local volumes from the free capacity of each storage server, and sends an instruction to each storage server. Each storage server creates a lead local volume having the capacity thus instructed.

As a result, the used capacity of each storage server can be determined from the compute server side, and a volume can be created in each storage server.

In the present invention, the block storage driver container operating on the container execution base is connected to the created lead local volumes of the plurality of storage servers, and uses a logical volume management program to create a volume in which each of the nodes are bundled together. The application program container of each compute server uses this volume as a scale-out volume.

As a result, a large-capacity scale-out volume can be used from the container execution base.

Thus, the present invention manages the free capacity of each storage server on the host side having the container orchestrator instead of the storage side, and bundles together the lead local volumes provided by the storage servers, thereby providing a large-capacity and low read latency scale-out volume.

Although an embodiment of the present invention has been described above, the above embodiments have been described in detail in order to describe the present invention in an easy-to-understand manner, and the present invention is not necessarily limited to or by an embodiment having all the described configurations. Part of the configuration of one example can be substituted for the configuration of another example, or the configuration of another example can be added to the configuration of the one example. Moreover, it is possible to add other configurations to part of the configuration of each embodiment, and to delete or substitute part of the configuration of the embodiments. The configuration of the drawings illustrates what is considered to be necessary for the description, and does not necessarily illustrate all the configurations of the product.

Further, a configuration using physical servers was described in the embodiment, but the present invention is also applicable to a cloud computing environment using a virtual machine. The cloud computing environment has a configuration in which virtual machines/containers are operated on a system hardware configuration resulting from abstraction by a cloud provider. In that case, the server described in the embodiment is substituted for a virtual machine/container, and the storage array is substituted for a block storage service provided by a cloud provider.

What is claimed is:

1. A storage system, comprising:
a plurality of storage servers that includes a storage device and a controller that processes data inputted to and outputted from the storage device, the plurality of storage servers providing a lead local volume for inputting and outputting data to and from the storage device; and
a first compute server including a client,
wherein the first compute server
manages a free capacity of the plurality of storage servers,
individually provisions a storage capacity to each of the plurality of storage servers on the basis of the free capacity to provide the lead local volume, and
configures a first volume on the basis of a plurality of the lead local volumes provided, and provides the first volume to the client.

2. The storage system according to claim 1,
wherein the first compute server is a server including an environment with a container execution base,
wherein the client operates on the container execution base, and
a program operating on the container execution base is used to perform management of the free capacity, storage capacity provisioning, and provision of the first volume.

3. The storage system according to claim 2, further comprising a second compute server which includes a client,
wherein at least one of the plurality of storage servers provides the lead local volume to each of the first compute server and the second compute server.

4. The storage system according to claim 1,
wherein, in a case where the storage capacity of the first volume is increased, the first compute server refers to the free capacity of the plurality of storage servers and determines a storage server to which an increased storage capacity is to be provisioned,
wherein the storage server to which the increased storage capacity is provisioned increases the storage capacity provided as the storage capacity of the first volume.

5. A control method for a storage system that includes:
a plurality of storage servers that includes a storage device and a controller that processes data inputted to and outputted from the storage device, the plurality of storage servers providing a lead local volume for inputting and outputting data to and from the storage device; and
a first compute server including a client,
the control method comprising:
causing a compute server to
manage a free capacity of the storage device of the plurality of storage servers,
individually provision a storage capacity to each of the plurality of storage servers on the basis of the free capacity to provide the lead local volume, and
configure a first volume on the basis of a plurality of the lead local volumes provided, and provide the first volume to the client.
